(19) United States
(12) Patent Application Publication
(10) Pub. No.: US 2026/0109584 A1
(43) Pub. Date: Apr. 23, 2026

(54) OPERATOR GUIDANCE FOR THE USE OF A FORK CARRIAGE IN COMBINATION WITH A TILTROTATOR

(71) Applicant: Rototilt Group AB, Vindeln (SE)

(72) Inventor: Anders JONSSON, Vindeln (SE)

(73) Assignee: Rototilt Group AB, Vindeln (SE)

(21) Appl. No.: 19/112,800

(22) PCT Filed: Sep. 28, 2023
(86) PCT No.: PCT/EP2023/076963

§ 371 Date: Mar. 18, 2025

(30) Foreign Application Priority Data
Sep. 30, 2022 (SE) 2251138-0

(51) Int. Cl. B66F 9/24; B66F 9/075; B66F 9/12

(52) U.S. Cl. CPC B66F 9/24; B66F 9/0755; B66F 9/12

(57) ABSTRACT

The invention relates to a control system for a work machine for the use of a fork carriage with forks in combination with a tiltrotator, the tiltrotator comprising an upper part arranged to be mounted to a work arm of a work machine and a lower part that is rotatably and pivotally connected to the upper part, wherein the control system is configured to be activated when fork carriage is mounted on the lower part of the tiltrotator, the control system being characterised in that it includes an inclinometer arranged on the lower part of the tiltrotator for sensing the orientation of the lower part with respect to gravity, and a display unit arranged in an operator's cabin of the work machine, wherein the display unit is configured to illustrate the current orientation of the fork carriage at the lower part of the tiltrotator based on input from the inclinometer to assist the operator in keeping the lower part and the mounted fork carriage level with respect to gravity.

### TECHNICAL FIELD

The invention relates to a control system for a work machine adapted for the use of a fork carriage arranged on the work machine in combination with a tiltrotator. The invention also relates to a tiltrotator arrangement including such a control system and a tiltrotator.

### BACKGROUND

In construction work it has become more and more common to utilise a tiltrotator at the outer end of a work arm of a work vehicle, such as an excavator. The tiltrotator has a lower holder 8 for carrying a tool such as a compactor, hydraulic hammer, grapple, bucket etc. The tiltrotator simplifies the use of different tools as it is furnished with a hydraulic tool coupler for a simple change of tools and provides both a tilting movement and an unlimited rotational movement. With a tiltrotator mounted on its work arm the excavator becomes a more useful tool carrier, in that functionality of the tool is increased when mounted on a tiltrotator.

It has also become apparent that the use of a tiltrotator in combination with a fork carriage may be very effective. Namely, the usability of a fork carriage on the work arm of a work machine with a tiltrotator is very advantageous in that the fork carriage may be directed in any rotational direction, not only a forward direction with respect to the work vehicle, and that the tiltrotator provides a possibility of adapting the inclination of the fork carriage.

However, there is a concern in the business branch that the safety may be a problem and some manufacturers and distributors have chosen not to offer fork carriages on excavators in combination with tiltrotators because of a concern that the combination may not be secure enough and that there may be risk of accidents due to tipping loads when carried by the forks of a fork carriage arranged on a tiltrotator.

In the German attached patent publication DE 10 2019 106 445 A1 it is illustrated how a fork carriage may be attached to a tiltrotator so as to be used with a tiltrotator. The publication does however not address the risks involved in the handling of a fork carriage with a tiltrotator, such as the risk of dropping a load carried by the fork carriage.

It would be advantageous to achieve a system overcoming, or at least alleviating, at least one or some of the drawbacks of the prior art. In particular, it would be desirable to increase the safety when a fork carriage is used on a work machine in combination with a tiltrotator.

### SUMMARY OF THE INVENTION

It is an object of the invention to provide a system with an increased safety with respect to conventional systems when a fork carriage is used on a work machine in combination with a tiltrotator.

According to a first aspect the invention relates to a control system for a work machine for the use of a fork carriage with forks in combination with a tiltrotator, the tiltrotator comprising an upper part arranged to be mounted to a work arm of the work machine and a lower part that is pivotally connected to the upper part, wherein the control system is configured to be activated when the fork carriage is mounted on the lower part of the tiltrotator, the control system comprising:
an inclinometer configured to be arranged on the lower part of the tiltrotator for sensing the orientation of the lower part with respect to gravity, and
a control unit arranged to gather information from the inclinometer and to relate said information to the orientation of the forks of the fork carriage, wherein the control unit is connectable to a display unit configured to be arranged in an operator's cabin of the work machine, the display unit being configured to illustrate the current orientation of the forks of the fork carriage based on information from the inclinometer to assist the operator in keeping the forks of the fork carriage level with respect to gravity.

In embodiments of the invention the control system also comprises a display unit to be arranged in an operator's cabin of the work machine.

In embodiments of the invention the control system is configured to be manually activated by the operator when a fork carriage is mounted to the lower part of the tiltrotator.

In embodiments of the invention the control system is configured to be activated by means of a tool recognising unit configured to automatically recognise when a fork carriage is mounted to the lower part of the tiltrotator.

In embodiments of the invention the control system further comprises an audio unit configured to emit an audio signal to warn the operator if an inclination of the fork carriage sensed by the inclinometer exceeds a first threshold inclination with respect to a level orientation of the lower part of the tiltrotator.

In embodiments of the invention the control system further comprises a vibration unit configured to provide vibrating warning feedback to the operator via a manoeuvring device to warn the operator if the manoeuvring device is controlled in such a manner that an undesired inclination of the fork carriage is worsened.

In embodiments of the invention the control system is configured to control the display unit to illustrate the current orientation of the lower part of the tiltrotator in reference to a desired orientation to assist the operator in bringing the fork carriage to a level orientation

Specifically, the control system may be configured to control the display unit to illustrate the position of the fork carriage by means a plurality of icons including a first icon illustrating the sideways inclination of the fork carriage and a second icon illustrating the forward-backward inclination of the fork carriage.

In embodiments of the invention the control system further comprises a rotation sensor to register the rotational position of the lower part of the tiltrotator and hence of the fork carriage when arranged on the tiltrotator, the control unit being configured to gather information from the rotation sensor and to relate said information to the orientation of the forks of the fork carriage and the display unit being configured to illustrate the current orientation of the forks of the fork carriage based on information from the rotation sensor.

The rotation sensor may be arranged to register the rotational position of the lower part of the tiltrotator with respect to an initial position, in which the fork carriage is directed either straight towards the operator or straight away from the operator.

According to a second aspect the invention relates to a tiltrotator arrangement including a tiltrotator with an upper part arranged to be mounted to a work arm of a working machine and a lower part that is pivotally connected to the upper part, wherein the tiltrotator arrangement also comprises
a control system as defined above, the control system being configured to be used when a pallet loader is mounted on the lower part of the tiltrotator, and
a display unit configured to illustrate the current orientation of the forks of the fork carriage based on information from the inclinometer to assist the operator in keeping the forks of the fork carriage level with respect to gravity

Other embodiments and advantages will be apparent from the detailed description and the appended drawings.

It is understood that all the various examples of the control system for a work machine as disclosed herein also applies for the tiltrotator arrangement comprising such a control system.

### BRIEF DESCRIPTION OF THE DRAWINGS

Below, specific embodiments of the invention will be described with reference to the appended drawings, of which:

FIG. 1 shows a work vehicle with a fork carriage arranged on a tiltrotator at its work arm,

FIG. 2 shows a fork carriage arranged on a tiltrotator,

FIGS. 3-6 are schematic views of a first embodiment of a display unit of a control system in accordance with the invention, and

FIGS. 7-15 are schematic views of a second embodiment of a display unit of a control system for different positions of the forks of a fork carriage.

### DETAILED DESCRIPTION OF THE SHOWN EMBODIMENTS

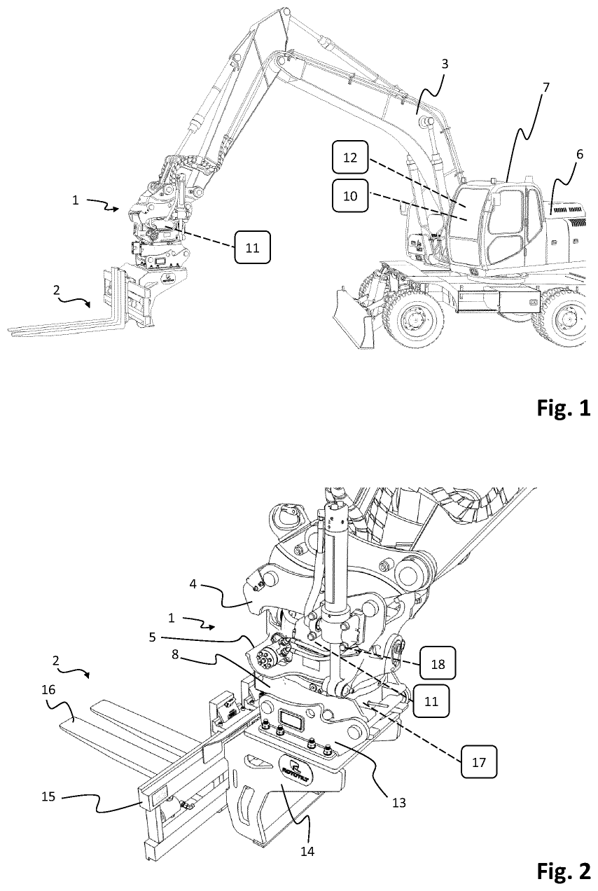

In FIG. 1 a work machine 6 is illustrated on which a fork carriage 2 is mounted on a tiltrotator 1 arranged at the outer end of a work arm 3 of the work machine 6. The work machine 6 includes a work arm 3 arranged to carry a tool, and a cabin 7 in which an operator of the work machine will be positioned during operation of the work machine 6.

In accordance with the invention a control system is provided on the work machine. The control system is configured for the use of a fork carriage 2 arranged on the work machine in combination with a tiltrotator 1. The tiltrotator 1 may be of a conventional type comprising an upper part 4 arranged to be mounted to the work arm 3 of the work machine 6 and a lower part 5 that is pivotally connected to the upper part 4 of the tiltrotator 1.

The fork carriage 2 includes forks 16 arranged to extend horizontally and to carry loads arranged on pallets. Further, a vertical support section 15 is arranged at an inner end of the forks 16 to provide a support for a pallet and its load when carried by the fork carriage 2. A body construction 14 connects the support section 15 and the forks 16 to a tool coupler 13 arranged to be attached to a holder 8 at the lower part 5 of the tiltrotator 1.

In fact, the lower part 5 of the tiltrotator 1, which is tiltable with respect to the upper part 4, may be said to involve two different parts in view of that the lower holder 8 is arranged to rotate with respect to a main portion of the lower part 5, said main portion including the rotation motor.

The control system includes a control unit 10 configured to be arranged on the work machine 6.

The control unit 10 is configured to be activated when a fork carriage 2 is mounted on the lower part 5 of the tiltrotator 1. The control system includes an inclinometer 11 arranged on the lower part 5 of the tiltrotator 1 for sensing the orientation of the lower part 5 of the tiltrotator with respect to gravity. The inclinometer 11 is calibrated to sense the orientation of the forks 16 of the fork carriage 2. Hence, there is no need to arrange an inclinometer or any other control arrangement on the fork carriage 2. Instead, the calibrated inclinometer 11 arranged on the lower part 5 of the tiltrotator 1 will provide a correct representation of the orientation of the forks 16 of the fork carriage 2.

In the shown embodiment, the inclinometer 11 is arranged on the main portion of the lower part 5 and not on the lower holder 8, which is rotatable with respect to the main portion.

In addition to the inclinometer 11 a rotation sensor 18 may be arranged to register the rotational position of the lower part 5 of the tiltrotator 1 and hence of the fork carriage 2 when arranged on the tiltrotator 1. The rotation sensor 18 may be arranged to register the rotational position of the lower part 5 of the tiltrotator 1 with respect to an initial position, in which the fork carriage 2 is directed either straight towards the operator or straight away from the operator.

A rotation sensor is, in itself, conventional to a person skilled in the art but it is conventionally only available to the operator as a rotational position, i.e., a degree with respect to initial position, not as a graphical illustration as in embodiments of the invention.

Further, the control system includes a display unit 12 arranged or configured to be arranged in an operator's cabin 7 of the work machine 6.

The display unit 12 is configured to illustrate the current orientation of the forks 16 of the fork carriage 2 at the lower part 5 of the tiltrotator 1 based on input from the inclinometer 11 to assist the operator to keep the forks 16 of the fork carriage 2 level with respect to gravity.

The control unit 10, the inclinometer 11, the rotation sensor 18 and the display unit 12 are schematically illustrated at proposed positions in FIG. 1. A more specific proposed position of the inclinometer 11 on the lower part 5 of the tiltrotator 1 is illustrated in FIG. 2. The display unit 12 may typically be configured to illustrate the current orientation of the lower part 5 of the tiltrotator 1 with the arranged fork carriage 2 in reference to a desired orientation to assist the operator to keep the fork carriage 2 in a level orientation or to bring it to a level orientation if it is tilted. Of course, if the orientation and inclination of the lower part 5 of the tiltrotator 1 is known, so is also the orientation and inclination of the fork carriage 2, in view of that the coupling between the lower part 5 of the tiltrotator 1 and the arranged fork carriage 2 guarantees the position of the fork carriage 2.

Below, the invention will be described with reference to a first and a second specific embodiment of a display unit 12. The invention is however not limited to any specific design of the display, but merely to the function thereof as presented in the claims. The description is only directed at explaining a possible implementation of the invention.

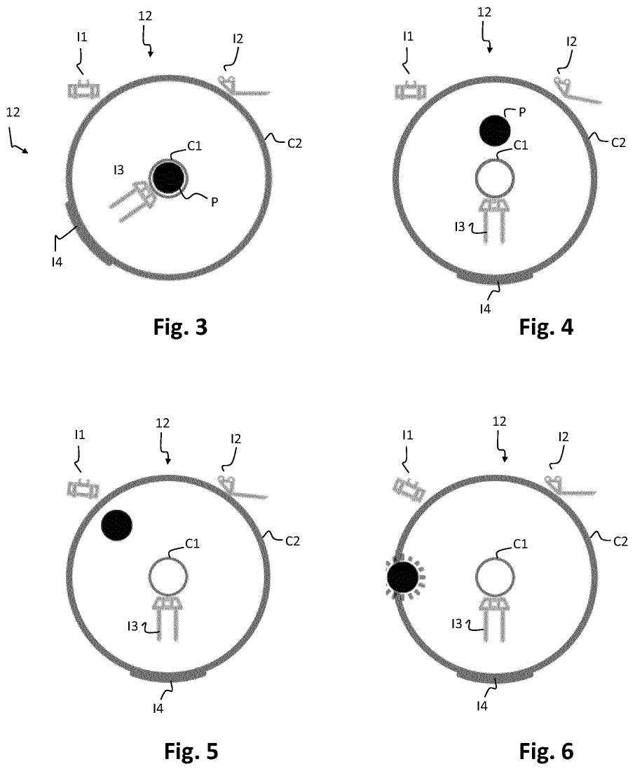

FIGS. 3-6 are schematic views of a first embodiment of a display unit 12 of a control system in accordance with the invention.

The display unit 12 should be positioned so as to be visible to the operator of the tiltrotator 1 during operation thereof. Specifically, the display unit 12 may be configured to be arranged in the operator's cabin. The display unit 12 may advantageously be a part of or integrated in a display unit arranged in the work machine 6. Hence, the control system does not need to include a specific display unit. Instead, the control system may be configured to be compatible with a display unit of a work machine 6.

For example, the software of the control system may be configured to be downloaded to a display unit arranged inside a vehicle. The control system does hence not need to involve a display when provided to a customer, instead it suffices that software is available to be run or downloaded to a display unit or to be run on a mobile display unit, such as a mobile phone.

In the shown first embodiment the orientation of the fork carriage 2 is illustrated in four different manners based on information from both the inclinometer 11 and the rotation sensor 18. In the upper left corner of the display a first icon 11 illustrates the sideways inclination of the fork carriage based on information from the inclinometer 11 and in the upper right corner a second icon 12 illustrates the forward tilting of the fork carriage also based on information from the inclinometer 11. In a central part of the display the current orientation of the fork carriage is illustrated in reference to a desired orientation to assist the operator in bringing the fork carriage to a level orientation. In the shown embodiment the orientation is illustrated as a relative position of an indication point P with respect to a centrally located circle C1 of corresponding size, such that the indication point P just barely fits inside this central circle C1. An outer circle C2 is arranged concentrically outside the central circle C1 to mark an outer border for an acceptable orientation of the fork carriage as illustrated by the indication point P. The illustration of the indication point P is based on information from both the inclinometer 11 and the rotation sensor 18.

A third icon 13 and a fourth icon 14 are, in the shown embodiment, arranged to illustrate the rotational position of the fork carriage in the plane orthogonal to the gravity based on information from the rotation sensor 18. The third icon 13 is illustrated in the shape of a fork carriage, and the fourth icon 14 is illustrated in the shape of a ring segment in connection to the outer circle C2.

In FIG. 3 the display unit 12 illustrates a fork carriage in a level orientation in which the fork carriage arranged on the lower holder 8 of the tiltrotator is in a level position with respect to gravity, meaning that a plane formed by the forks 16 of the fork carriage is orthogonal to the direction of the force of gravity. Hence, in FIG. 3 the display unit 12 illustrates the indication point P inside the central circle C1, indicating that the fork carriage 2 is level. Further, both the first icon 11 and the second icon 12 are in their initial positions indicating that the fork carriage is level with respect to the sideway inclination and the backward-forward tilting, respectively. The third icon 13 and the fourth icon 14 are pointing to the left and backwards, indicating the current rotational position of the fork carriage.

In FIG. 4 the display unit 12 illustrates a fork carriage where the indication point P is not inside the central circle C1, indicating that the fork carriage is not level. Specifically, the fork carriage is oriented such that the outer fork end of the fork carriage is pointed downwards, which is indicated both by an inclined position of the second icon 12 and in that the indication point P is outside of the central circle C1. The indication point P is however well inside the outer circle C2, such that there is no immediate risk of losing the load from the fork carriage.

In FIG. 5 the display unit 12 illustrates a fork carriage where the indication point P is outside the central circle C1, indicating that the fork carriage is not level, and both the first and second icons, 11 and 12 respectively, are offset. Hence, in this position the fork carriage is tilted both sideways and with the outer fork end of the fork carriage pointed downwards. The indication point P is however still inside the outer circle C2, such that there is no immediate risk of losing the load from the fork carriage.

In FIG. 6 the display unit illustrates a fork carriage where the indication point P is outside the central circle C1, and on its way outside the outer circle C2. In specific embodiments a warning may be issued when a specific threshold is exceeded, which may correspond to the crossing of the outer circle C2. Specifically, an audio signal may be issued. Also, a visual warning may be issued, for example as illustrated in the drawing, in that the indication point P starts blinking. Further, continued manipulation of the manoeuvring device may be prevented until the operator has acknowledged the crucial situation, for instance by pressing a button to unlock the manipulation of the manoeuvring device. Also, assisted manoeuvring of the manoeuvring device may be automatically provided, for instance by providing a button therefore, wherein the fork carriage will be automatically manoeuvred to a level position.

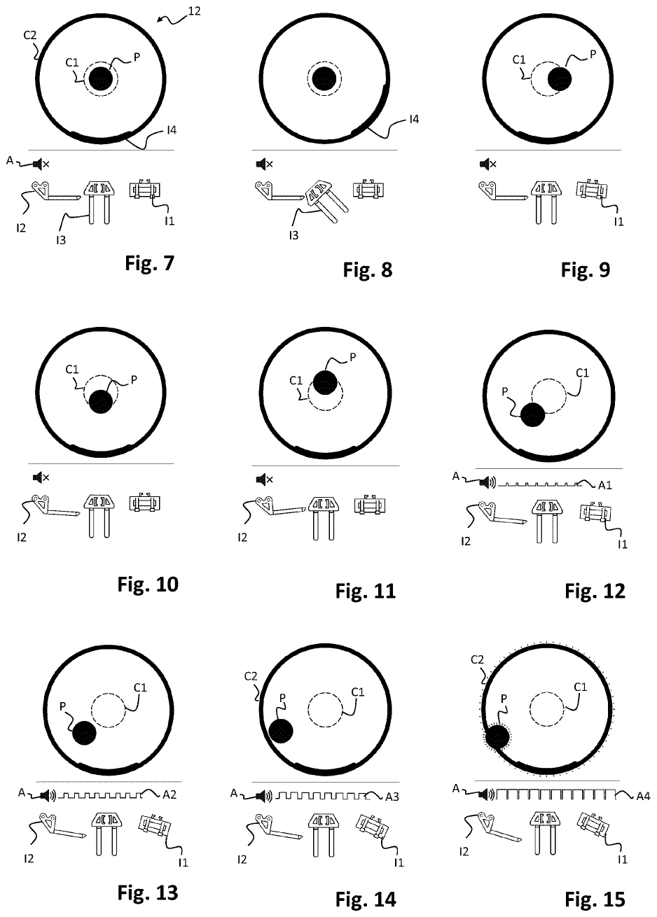

In FIGS. 7-15, a second embodiment of a display unit 12 of a control system in accordance with the invention is illustrated for different positions of the fork carriage 2.

In this embodiment the display of display unit 12 has an upper part with an indication point P, circles C1 and C2 and an icon 14, and a lower part with icons 11, 12, and 13. In embodiments of the invention only some of these icons appear on the display unit, such as for example the indication point P and the central circle C1.

The illustration in FIG. 7 corresponds to a situation where the fork carriage is in an initial position, i.e., in a level position and rotated straight backwards, towards the cabin 7 of the work machine 6. Hence, in FIG. 7 the display unit 12 illustrates the indication point P inside the central circle C1, indicating that the fork carriage is level. Further, both the first icon 11 and the second icon 12 are in their initial positions indicating that the fork carriage is level with respect to the sideway inclination and the backward-forward tilting, respectively. The third icon 13 and the fourth icon 14 both illustrate the rotational position of the fork carriage 2 in the plane orthogonal to the gravity and are both pointing downwards indicating that the fork 16 is in its initial position. The fourth icon 14 is represented as a circle portion in connection to an outer circle C2.

The control system may also be connected to an audio unit such as the speaker system of the work machine. In FIGS. 7-15 the audio unit is illustrated by an audio icon A, which may be provided to visually illustrate an audio signal. However, the audio icon A is primarily illustrated in the drawings of the display unit 12 to illustrate when an audio signal is emitted or not. In embodiments of the invention, no audio icon A is presented on the display unit.

In the situation shown in FIG. 7 no audible signal is issued, which is illustrated by an X next to the audio icon A.

In FIG. 8 the fork carriage 2 is rotated about 45° counter-clockwise with respect to the initial position, which is illustrated by the icons 13 and 14, which are pointing downwards to the right, corresponding to SE (southeast) on a compass. The indication point P is still centred inside the central circle C1 indicating that the forks 16 of the fork carriage 2 are level.

In FIG. 9 the fork carriage is tilting slightly to the side, specifically to the right side, which is illustrated by that a portion of the indication point P is outside of the central circle C1, and that the first icon 11 is tilted (to the right).

In FIGS. 10 and 11 the fork carriage is tilting slightly forward and backwards, respectively, which is illustrated by that a portion of the indication point P is outside of the central circle C1, above and below, respectively, and that the second icon 11 is tilted forward and backwards, respectively.

For all of the situations illustrated in FIGS. 7-11, the deviation from a level position of the fork carriage is so small that a major part of the indication point P is inside of the central circle C1, and no audio warning signal is issued.

In FIGS. 12-15 , the inclination of the fork carriage increases, and as the inclination is such that a major part of the indication point P comes outside of the central circle C1, as is illustrated in FIG. 12, a sublime first audio signal A1 is issued to let the operator know that the tilting has surpassed a first threshold, corresponding to an inclination of for example about 2-3°. In FIG. 13, the inclination of the fork carriage is such that the whole indication point P comes outside of the central circle C1 wherein a second threshold has been surpassed, corresponding to a slightly larger inclination, for example 4-5°, wherein a second audio signal A2 may be issued, which may have a higher amplitude and/or a higher frequency than the first audio signal A1 in order to make sure that the operator receives the warning.

In FIG. 14 the inclination of the fork carriage is such that the indication point P is getting close to the outer circle C2, wherein a third audio signal A3 may be issued, which may have an even higher amplitude and/or a higher frequency than the second audio signal A2.

In FIG. 15 the inclination of the fork carriage is such that an accident is approaching if the fork carriage would be further inclined in the wrong direction. At this point the indication point P has broken the outer circle C2, wherein a further a visual warning may be issued, such that a blinking signal or a change of colour in the display. For example, the outer circle C2 may change colour from a neutral colour to a red or yellow waring colour. Also, at this point, a marked (irritating) fourth audio signal A4 may be issued to urge the operator to correct the situation.

Of course, although represented as four different audio signals A1-A4, the warning sound may preferably be increased in amplitude and/or frequency as a function of the inclination of the forks without apparent steps.

The control system may be furnished with a “back-to-initial-position” button that the operator may press have an automatic rectifying of the inclination of the fork carriage 2 into a level position. This may be very useful if the operator loses control of the fork carriage.

The control system may be configured to be manually activated by the operator when a fork carriage is mounted to the lower part 5 of the tiltrotator 1. Further though, the control system may be configured to be activated by means of a tool recognising unit configured to automatically recognise when a fork carriage is mounted to the lower part 5 of the tiltrotator 1. For example, the fork carriage 2 may be provided with a recognizable identification, such as an RFID, wherein a sensor 17 is arranged either on the tiltrotator or at the outer end of the work arm to recognize the recognizable identification on the fork carriage 2. In the embodiment shown in FIG. 2 a sensor 17 is schematically illustrated at the lower part 5 of the tiltrotator 1.

The tiltrotator 1 may comprise an electric swivel (not shown) to provide electricity end electric communication lines to the inclinometer 11, and if installed, a sensor 17.

As indicated above, the control system may comprise an audio unit A configured to emit an audio signal to warn the operator if an inclination of the fork carriage 2 sensed by the inclinometer 11 exceeds a first threshold inclination with respect to a level orientation of the lower part 5.

Also, the control system may comprise a vibration unit (not shown) configured to provide vibrating warning feedback to the operator via a manoeuvring device (not shown) to warn the operator if the manoeuvring device is controlled in such a manner that an undesired inclination of the fork carriage 2 is worsened. The manoeuvring device may typically be a joystick.

Above, the invention has been described with reference to specific embodiments. The invention is however not limited to these embodiments. It is obvious to a person skilled in the art that other embodiments are possible within the scope of the following claims.

1. A control system for a work machine for the use of a fork carriage with forks in combination with a tiltrotator, the tiltrotator comprising an upper part arranged to be mounted to a work arm of the work machine and a lower part that is pivotally connected to the upper part, wherein the control system is configured to be activated when the fork carriage is mounted on the lower part of the tiltrotator, the control system being characterised in that it includes:
an inclinometer configured to be arranged on the lower part of the tiltrotator for sensing the orientation of the lower part with respect to gravity, and
a control unit arranged to gather information from the inclinometer and to relate said information to the orientation of the forks of the fork carriage wherein the control unit is connectable to a display unit configured to be arranged in an operator's cabin of the work machine the display unit being configured to illustrate the current orientation of the forks of the fork carriage based on information from the inclinometer to assist the operator in keeping the forks of the fork carriage level with respect to gravity.

2. The control system according to claim 1, wherein the control system is configured to be manually activated by the operator when a fork carriage is mounted to the lower part of the tiltrotator

3. The control system according to claim 1, wherein the control system is configured to be activated by means of a tool recognising unit configured to automatically recognise when a fork carriage is mounted to the lower part of the tiltrotator.

4. The control system according to claim 1, further comprising an audio unit configured to emit an audio signal to warn the operator if an inclination of the fork carriage sensed by the inclinometer exceeds a first threshold inclination with respect to a level orientation of the lower part of the tiltrotator.

5. The control system according to claim 1, further comprising a manoeuvring device configured to be hand manoeuvred by the operator to control the tiltrotator and vibration unit configured to provide a vibration warning feedback to the operator via said manoeuvring device to warn the operator if the manoeuvring device is controlled in such a manner that an undesired inclination of the forks of the fork carriage is worsened.

6. The control system according to claim 1, wherein the control system is configured to control the display unit to illustrate the current orientation of the forks of the fork carriage in reference to a desired orientation in a horizontal plane to assist the operator in bringing the forks of the fork carriage to a level orientation.

7. The control system according to claim 6, wherein the control system is configured to control the display unit to illustrate the position of the fork carriage by means a plurality of icons including a first icon illustrating the sideways inclination of the forks of the fork carriage and a second icon illustrating the forward-backward inclination of the forks of the fork carriage

8. The control system according to claim 1, further comprising a rotation sensor to register the rotational position of the lower part of the tiltrotator and hence of the fork carriage when arranged on the tiltrotator, the control unit being configured to gather information from the rotation sensor and to relate said information to the orientation of the forks of the fork carriage and the display unit being configured to illustrate the current orientation of the forks of the fork carriage based on information from the rotation sensor

9. The rotation sensor according to claim 8, may be arranged to register the rotational position of the lower part of the tiltrotator with respect to an initial position, in which the fork carriage is directed either straight towards the operator or straight away from the operator.

10. A tiltrotator arrangement including a tiltrotator with an upper part arranged to be mounted to a work arm of a working machine and a lower part that is rotatably and pivotally connected to the upper part, characterised in that that the tiltrotator arrangement also comprises
a control system according to any one of the preceding claims, and
a display unit configured to illustrate the current orientation of the forks of the fork carriage based on information from the inclinometer to assist the operator in keeping the forks of the fork carriage level with respect to gravity.
